(19) United States
(12) Patent Application Publication
(10) Pub. No.: US 2009/0262027 A1
(43) Pub. Date: Oct. 22, 2009

(54) Dual-Band Antenna

(76) Inventor: Min-Shun Hsu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/426,277

(22) Filed: Apr. 19, 2009

(30) Foreign Application Priority Data
Apr. 21, 2008 (TW) 097114471

(51) Int. Cl. H01Q 1/38

(52) U.S. Cl. 343/700 MS

(57) ABSTRACT

A dual-band antenna is disclosed and used for receiving or transmitting a first frequency band signal corresponding to a first central frequency and a second frequency band signal corresponding to a second central frequency. The dual-band antenna includes a first radiator, a feed line, a second radiator, and two parallel substrates each of which a grounding plane is installed on. The first and second radiators are respectively installed on the substrates and spatially overlap to each other in part. The first radiator receives and transmits the first and second frequency band signals and includes a first metal strip, having a plurality of bends, and a second metal strip. The second metal strip and the feed line are coupled to the first metal strip. The second radiator is used for enhancing the efficiency of receiving the second frequency band signal for the first radiator.

### BACKGROUND OF THE INVENTION

1. Field of the Invention

The present invention relates to a dual-band antenna, and more particularly, to a dual-band antenna implemented on a printed circuit board for wireless communication apparatus.

2. Description of the Prior Art

Antennas play an important role in delivering and switching wireless signal by means of transmitting or receiving radio waves. Recently, with the thriving development of wireless communication products, antenna design has tended to dual-band, smaller size and low-cost. As known so far, a printed-circuit antenna has led the trend, where an inverted F antenna is applied to wireless communication products most widely.

Please refer to FIG. 1, which is a schematic diagram of a dual-band inverted F antenna 10 according to the prior art. The dual-band antenna 10 includes inverted F antennas 12 and 14 receiving a high frequency signal and a low frequency signal through paths L1 and L2, respectively. Nevertheless, for the dual-band antenna 10, the antennas 12 and 14 form an extra resonance frequency band due to mutual interference and thereby cause load effect. Therefore, in order to increase impedance bandwidth, the dual-band antenna 10 of the prior art needs an extra external circuit to achieve impedance match.

### SUMMARY OF THE INVENTION

It is therefore an objective of the present invention to provide a compact dual-band antenna of a wireless communicate device which can be implemented on a printed circuit board and has good performance in impedance bandwidth and antenna field pattern.

The present invention provides a dual-band antenna which is utilized to receive and transmit a first frequency band signal corresponding to a first central frequency and a second frequency band signal corresponding to a second central frequency. The dual-band antenna comprises a first substrate, a second substrate, a first grounding plane, a second grounding plane, a first radiator, a feed line and a second radiator. The first substrate comprises a first plane. The second substrate comprises a second plane which is parallel with the first plane. The first grounding plane is installed on the first plane of the first substrate. The second grounding plane is installed on the second plane of the second substrate. The first radiator is installed on the first plane and used for receiving and transmitting the first frequency band signal and the second frequency band signal. The first radiator comprises a first metal strip and a second metal strip. The first metal strip comprises a second end, a first end opened, and a plurality of bends, and the second metal strip comprises a first end opened and a second end coupled to the second end of the first metal strip. The feed line is installed on the first plane and coupled to the second end of the first mental strip. The second radiator is installed on the second plane and coupled to the second grounding plane, and is utilized to enhance efficiency of receiving and transmitting the second frequency band signal for the first radiator. Projection of the second radiator along the first direction is partially overlapped with projection of the first radiator along the first direction.

Preferably, the second radiator comprises a third metal strip and a forth metal strip. The third metal strip comprises a bend, one open end and the other end coupled to the second grounding plane. The forth metal strip comprises a bend, one end opened and the other end coupled to the second grounding plane wherein a length of the forth metal strip corresponds to one-forth of a wave length corresponding to the second central frequency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a dual-band inverted F antenna according to the prior art.

FIG. 2 is a structure diagram of a dual-band antenna according to an embodiment of the present invention.

FIG. 3 is a top view of the dual-band antenna according to FIG. 2.

FIG. 4 is a bottom view of the dual-band antenna according to FIG. 2.

FIG. 5 is a schematic of a dual-band antenna for a wireless universal serial bus according to an embodiment of the present invention.

FIG. 6 is a top view of the dual-band antenna according to FIG. 5.

FIG. 7 is a bottom view of the dual-band antenna according to FIG. 5.

FIGS. 8 and 9 are frequency response schematic diagrams of the dual-band antenna according to FIG. 5.

FIGS. 10-12 are field pattern diagrams of a horizontally polarized dual-band antenna at 2.4 GHz in different planes according to FIG. 5.

FIGS. 13-15 are field pattern diagrams of a horizontally polarized dual-band antenna at 5.5 GHz in different planes according to FIG. 5.

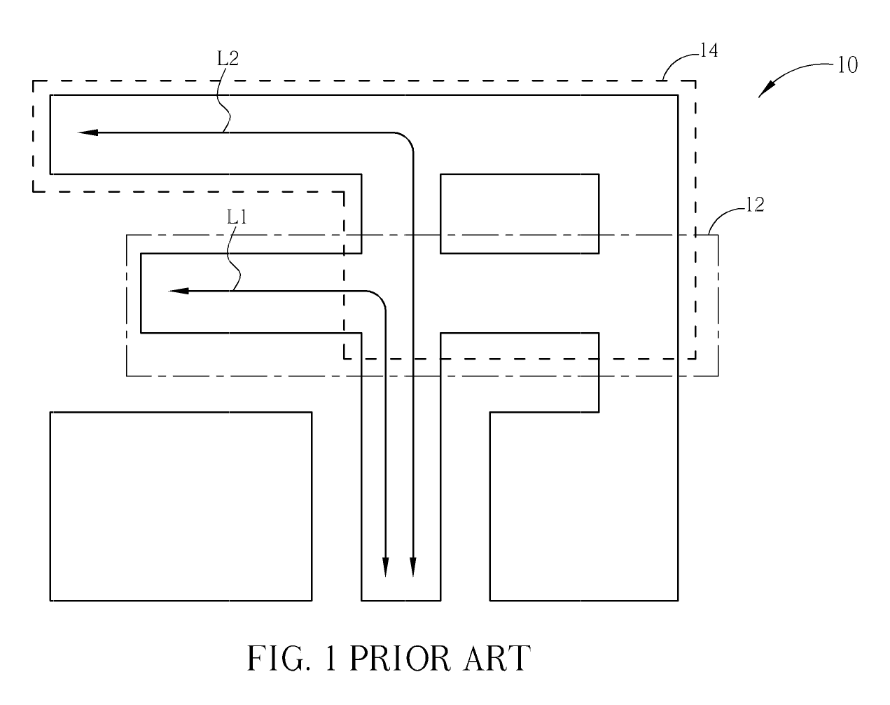

### DETAILED DESCRIPTION

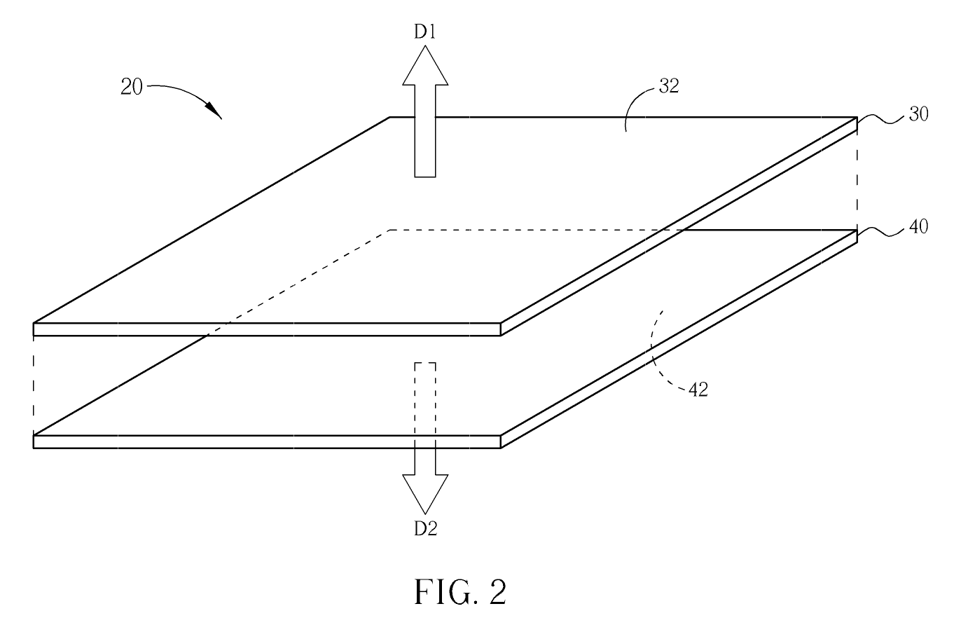

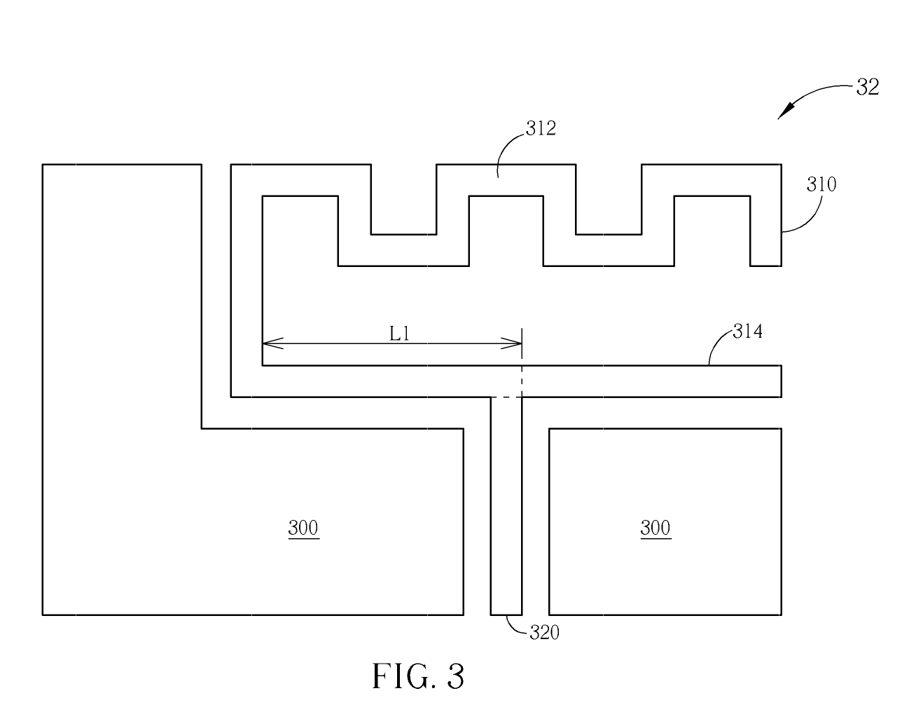

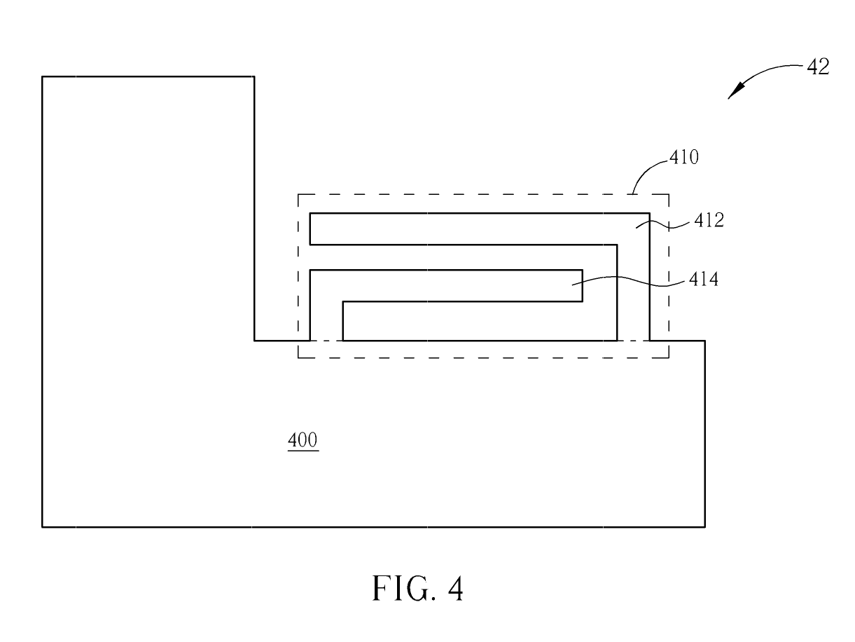

Please refer to FIG. 2-FIG. 4. FIG. 2 is a structure diagram of a dual-band antenna 20 according to an embodiment of the present invention. FIGS. 3 and 4 are a top view and bottom view of the dual-band antenna 20, respectively. The dual-band antenna 20 is utilized for transmitting and receiving a first frequency band signal FB1 corresponding to a first central frequency FC1 and a second frequency band signal FB2 corresponding to a second central frequency FC2. The dual-band antenna 20 includes a first substrate 30, a second substrate 40, a first grounding plane 300, a second grounding plane 400, a first radiator 310, a feed line 320 and a second radiator 410. Preferably, to meet IEEE (Institute of Electrical and Electronics Engineers) 802.11 a/b/g/n, the dual-band antenna 20 works at the first central frequency of 2.4 GHz (Gigahertz) and the second central frequency of 5.5 GHz.

First of All, the first substrate 30 is parallel with the second substrate 40 in FIG. 2. The first substrate 30 and the second substrate 40 can be jointed mutually, or a printed circuit board or a dielectric substrate can be inserted in between the first substrate 30 and the second substrate 40. Preferably, the first substrate 30 and the second substrate 40 are made of glass fiber FR4. The first substrate 30 includes a first plane 32 facing toward a direction D1 that is vertical with the first plane 32. In contrast, the second plane 40 includes a second plane 42 facing toward a direction D2 that is vertical with the second plane 42.

In FIG. 3, the first grounding plane 300, the first radiator 310 and the feed line 320 are installed on the first plane 32 of the first substrate 30. By such arrangement, the first radiator 310 functions as a monopole antenna. The first radiator 310 includes a first metal strip 312 and a second metal strip 314, where the first metal strip 312 includes a plurality of bends, one open end and the other end coupled to the second metal strip 314 and the feed line 320.

A length of the first metal strip 312 can be somewhat longer or less than one-forth of a wave length corresponding to the first central frequency FC1. Thus, the first frequency band signal FB1 can be received by the first radiator 310. Furthermore, the input impedance caused by the second metal strip 314 of the first radiator 310 and a segment L1 of the first metal strip 312 is much less than open end impedance of the first metal strip 312. In this case, a second order resonance frequency of the first radiator 310 drops from the triple of the first central frequency FC1 down to the second central frequency FC2 such that the second frequency band signal FB2 can be received by the first radiator 310.

In FIG. 4, the second grounding plane 400 and the second radiator 410 are installed on the second plane 42. The second radiator 410 includes a third metal strip 412 and a forth metal strip 414. The third metal strip 412 and the forth metal strip 414 form a structure of two inverted Ls toward each other, where each of the inverted Ls has one end opened and the other end coupled to the second grounding plane 410. Preferably, a length of the forth metal strip 414 corresponds to one-forth of a wave length corresponding to the second central frequency FC2.

In addition, projection of the second radiator 410 and the first radiator 310 along the direction D1, especially projection of the segment of metal strip L1 and the second metal strip 314, is mutually overlapped with each other such that the area where the third metal strip 412 and a forth metal strip 414 overlap with the first radiator 310 can form two inverted F antennas. When the feed line 320 feeds or receives signals, the first radiator 310 has a capacitive coupling feed to the second radiator 410. Thus, the second radiator 410 can increase the impedance bandwidth of the dual-band antenna 20 around the second central frequency FC2 to enhance efficiency of receiving and transmitting the second frequency band signal FB2 for the first radiator 310.

Please note that, for implementation of the first radiator 310 having far less input impedance than the open end impedance thereof, the number of bends of the first metal strip 312 and the total length of the first radiator 310 can be determined by those skills in the art according some factors such as material of metal strips, the attributes of substrates, material of a feed line, etc.

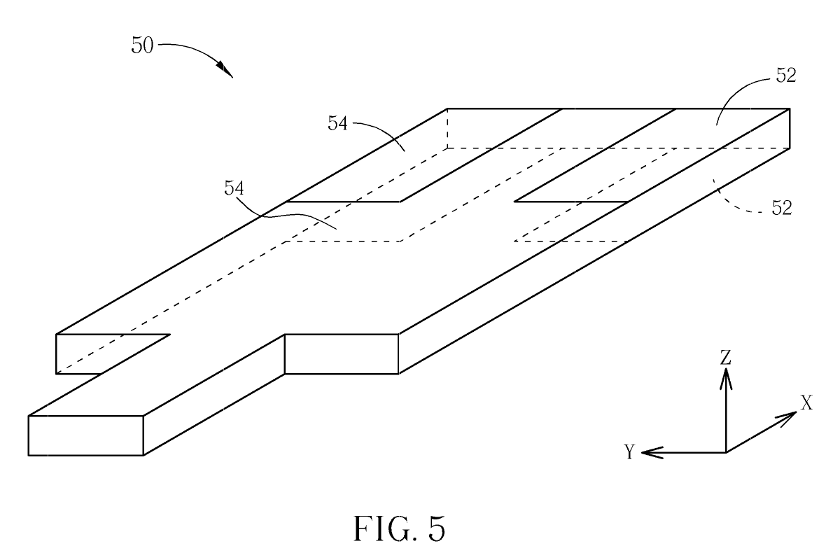

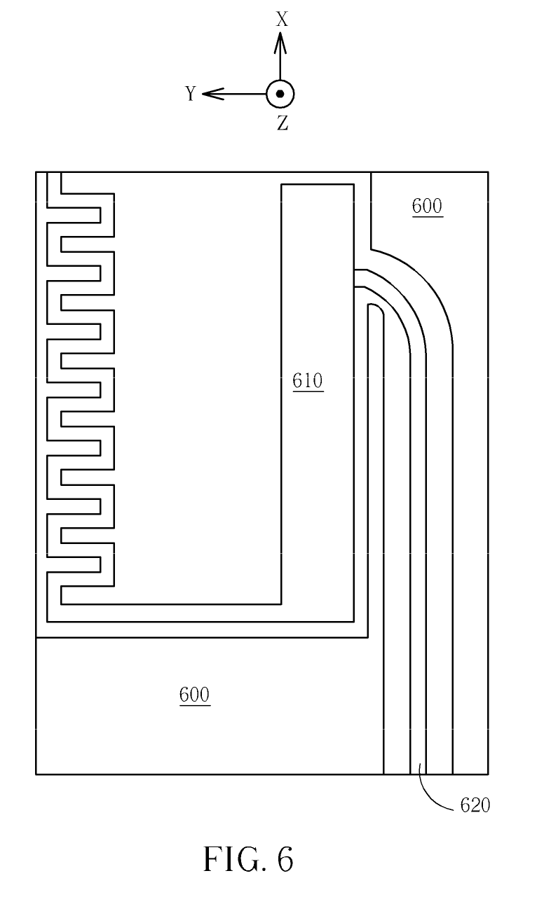

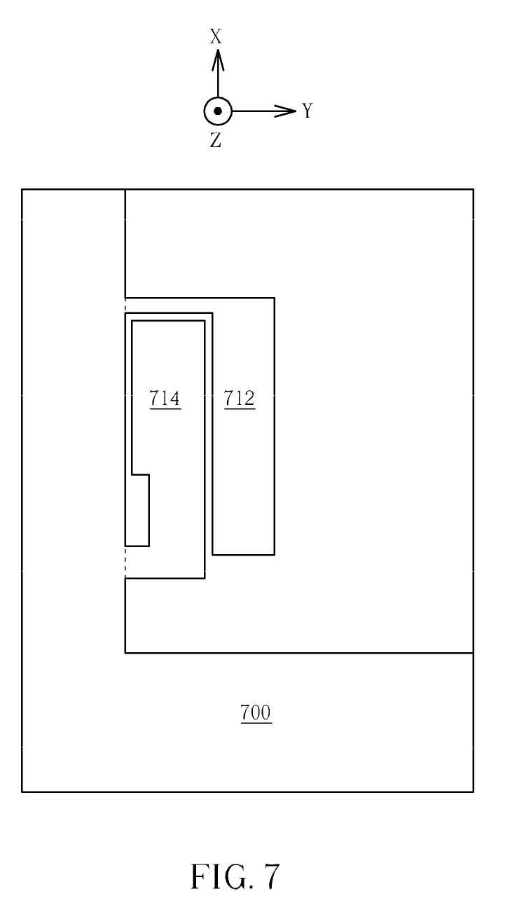

Please refer to FIG. 5, which is a schematic diagram of dual-band antennas 52 and 54 for a wireless universal serial bus interface device 50 according to an embodiment of the present invention. The dual-band antennas 52 and 54 have their antennas symmetric to each other and installed on the two sides of the interface device 50 to meet the system requirement for two inputs and two outputs. Besides, the dual-band antennas 52 and 54 are implemented on an FR4 substrate and combined with a printed circuit board. The parameters of the FR4 substrate are as follows: a relative permittivity εr=4.3, a thickness h=1 mm (millimeter), and a dissipation factor tan δ=0.023. Please refer to FIG. 6 and FIG. 7, which are top and bottom views of the dual-band antenna 52, respectively. As shown in FIG. 6 and FIG. 7, the dual-band antenna 52 is similar to the dual-band antenna 20, where a first radiator 610 has a plurality of bends and has two ends opened, and the feed line 620 is a micro strip feed line. Moreover, a single dual-band antenna covers an area of 13.5 mm×7.5 mm, and a total area of the interface device 50 is 2 cm (centimeter)×6 cm.

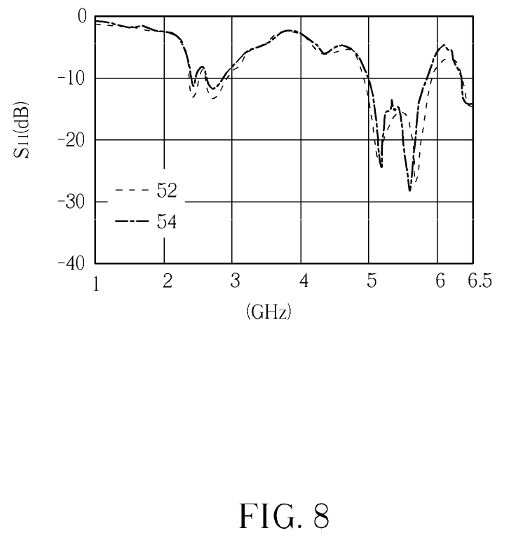

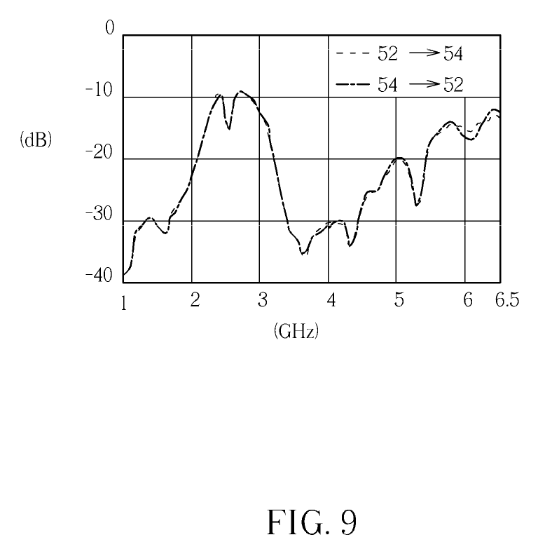

Please refer to FIG. 8 and FIG. 9. FIG. 8 and FIG. 9 are schematic diagrams of frequency responses of the dual-band antennas 52 and 54 according to FIG. 5. Scatter parameters S11 of the dual-band antennas 52 and 54 based on practical measurements are shown in FIG. 8, where the X-axis and Y-axis represent frequency in GHz and power in dB, respectively. From FIG. 8, the dual-antennas 52 and 54 have 10 dB-bandwidths of about 5 percent of the 2.4 GHz frequency band and 18 percent of the 5.5 GHz frequency band. On the other hand, isolation parameters of the dual-band antenna 52 and 54 are shown in FIG. 9. The dual-band antennas 52 and 54 approximately have isolation of 9 dB at the 2.4 GHz frequency band and 13 dB at the 5.5 GHz frequency band.

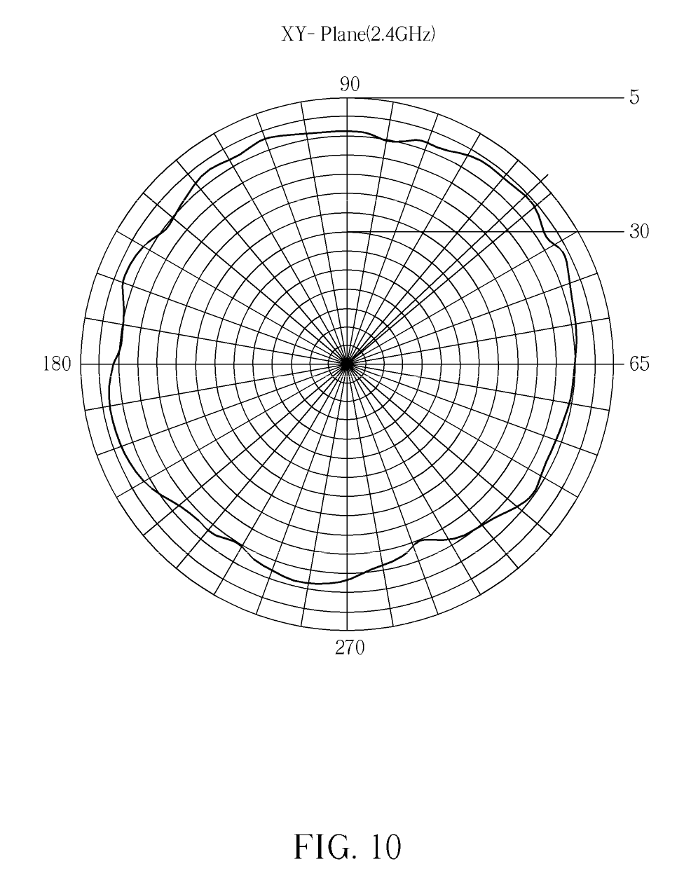

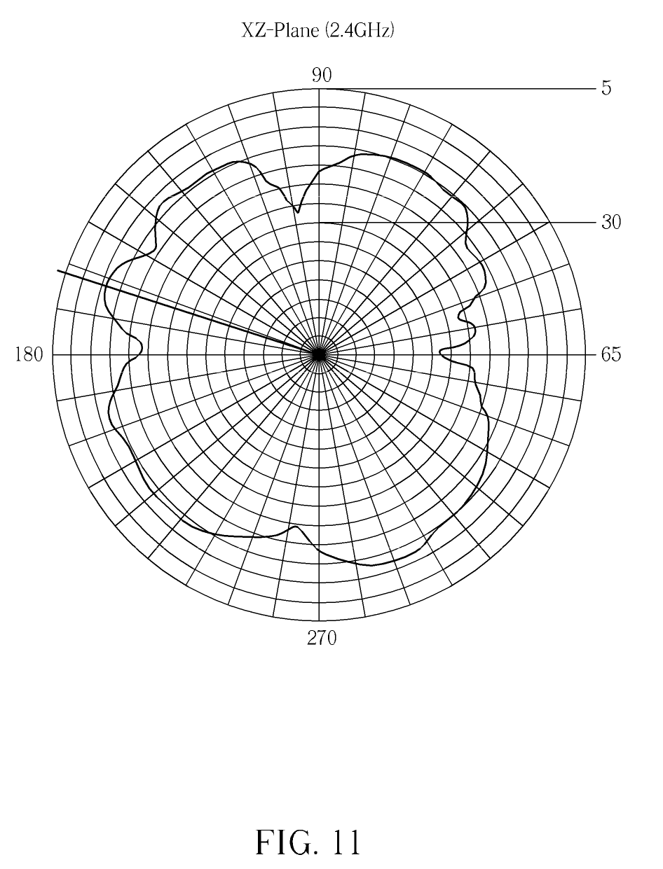

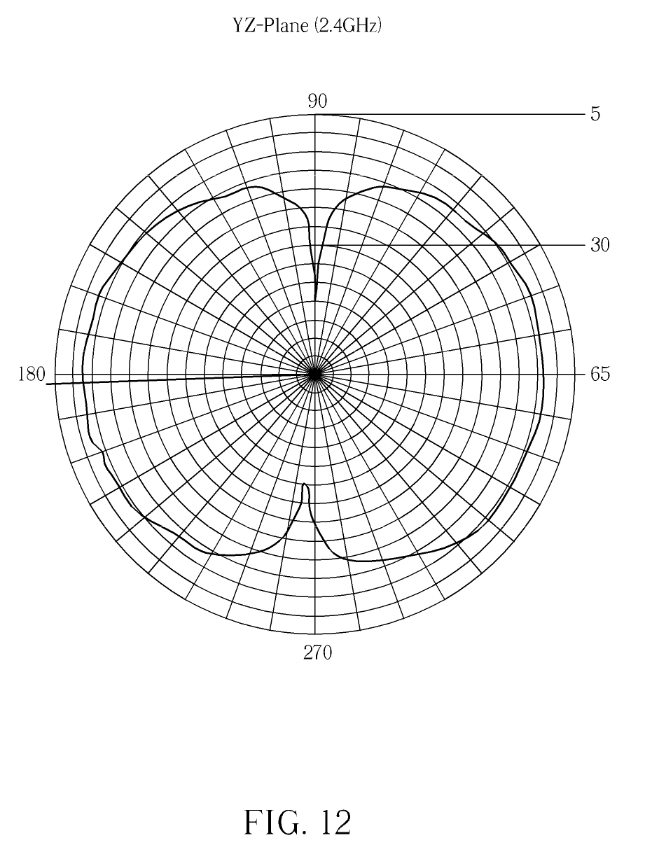

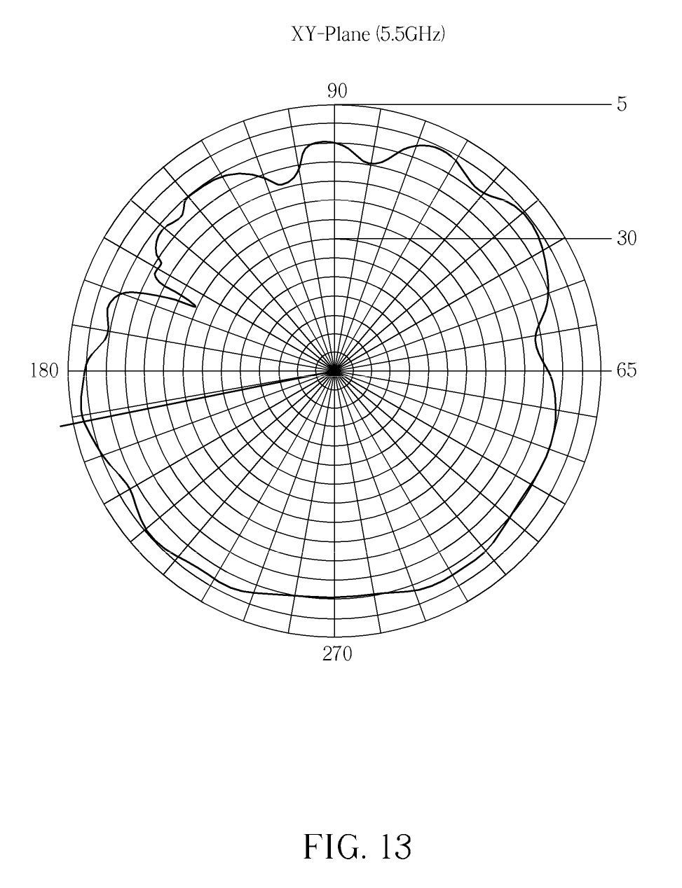

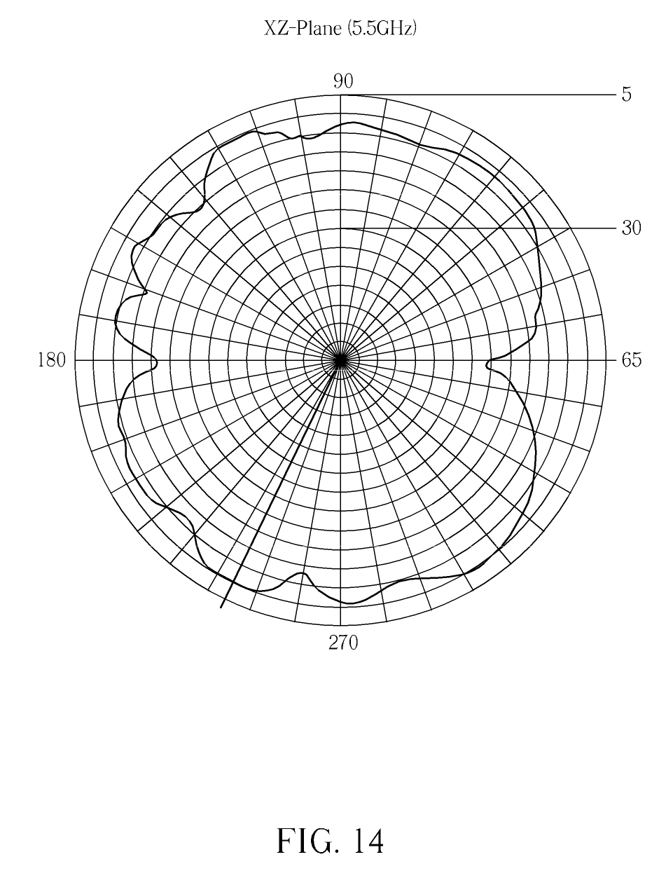

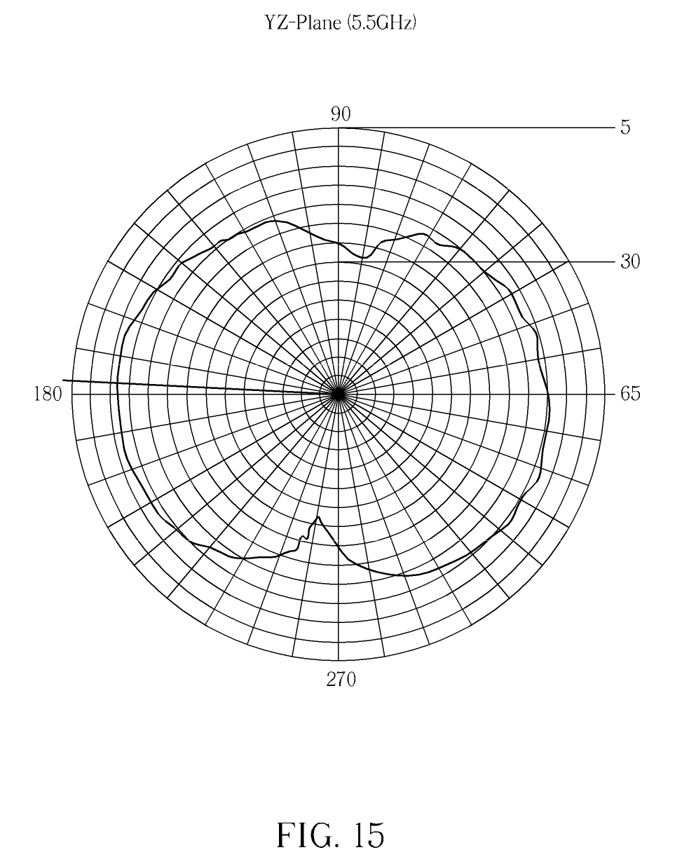

Please refer to FIGS. 10-15, which are field pattern diagrams of the dual-band antenna 52 under horizontal polarization. FIGS. 10-12 show field diagrams of XY, XZ and YZ planes when the dual-antenna 52 works at 2.4 GHz, whereas FIGS. 13-15 show field diagrams of XY, XZ and YZ planes when the dual-antenna 52 works at 5.5 GHz. As can be seen from FIGS. 10-15, a dual-band antenna has a competent omni-directional field pattern.

In conclusion, the dual-band antennas of the embodiments of the present invention have no need of extra-circuits and can have a better impedance bandwidth and a uniform filed distribution. In addiction, the dual-band antennas of the embodiments of the present invention have a compact size and are able to be implemented on printed circuit board, thereby being suitable for the wireless communication applications.

Those skilled in the art will readily observe that numerous modifications and alterations of the device and method may be made while retaining the teachings of the invention.

What is claimed is:

1. A dual-band antenna for receiving and transmitting a first frequency band signal corresponding to a first central frequency and a second frequency band signal corresponding to a second central frequency, the dual-band antenna comprising:
a first substrate comprising a first plane;
a second substrate comprising a second plane paralleling the first plane;
a first grounding plane installed on the first plane of the first substrate;
a second grounding plane installed on the second plane of the second substrate;
a first radiator installed on the first plane, for receiving and transmitting the first frequency band signal and the second frequency band signal, the first radiator comprising:
a first metal strip comprising a second end, a first end opened, and a plurality of bends; and
a second metal strip comprising a first end opened and a second end coupled to the second end of the first metal strip;
a feed line installed on the first plane and coupled to the second end of the first mental strip; and
a second radiator installed on the second plane and coupled to the second grounding plane, for enhancing efficiency of receiving and transmitting the second frequency band signal for the first radiator, projection of the second radiator along a first direction being partially overlapped with projection of the first radiator along the first direction.

2. The dual-band antenna of claim 1, wherein a length of the first metal strip is longer than one-forth of a wave length corresponding to the first central frequency.

3. The dual-band antenna of claim 1, wherein a length of the first metal strip is less than one-forth of a wave length corresponding to the first central frequency.

4. The dual-band antenna of claim 1, wherein the first central frequency is located at 2.4 GHz.

5. The dual-band antenna of claim 1, wherein the second central frequency is located at 5.5 GHz.

6. The dual-band antenna of claim 1, wherein the second radiator comprises:
a third metal strip comprising a bend, one end opened and the other end coupled to the second grounding plane; and
a forth metal strip comprising a bend, one end opened and the other end coupled to the second grounding plane;
wherein a length of the forth metal strip corresponds to one-forth of a wave length corresponding to the second central frequency.

7. The dual-band antenna of claim 1, wherein the feed line is a micro metal strip.

8. The dual-band antenna of claim 1, wherein the first substrate and the second substrate are made of glass fiber FR4.
